(19) United States
(12) Patent Application Publication
(10) Pub. No.: US 2025/0115504 A1
(43) Pub. Date: Apr. 10, 2025

(54) SYSTEM FOR TREATING PRODUCED WATER RESULTING FROM OIL EXTRACTION AND PNEUMATIC FLOCCULATION METHOD BY INJECTION OF INERT GAS INTO HEAT EXCHANGERS

(71) Applicants: PETRÓLEO BRASILEIRO S.A. – PETROBRAS, Rio de Janeiro (BR); UNIVERSIDADE DE SÃO PAULO - USP, São Paulo (BR)

(72) Inventors: Aloisio Euclides ORLANDO JUNIOR, Rio de Janeiro (BR); Florisvaldo Edeleu BONI FILHO, São Carlos (BR); Gherhardt RIBATSKI, São Carlos (BR); Gabriel FURLAN, Rio de Janeiro (BR); Alex Roger ALMEIDA COLMANETTI, São Carlos (BR)

(21) Appl. No.: 18/907,719

(22) Filed: Oct. 7, 2024

(30) Foreign Application Priority Data
Oct. 9, 2023 (BR) 1020230209920

(51) Int. Cl. C02F 9/00; B01D 17/02; B01D 17/04; B01D 19/00; C02F 1/20; C02F 1/24; C02F 1/38; C02F 1/40; C02F 1/52; C02F 101/32; C02F 103/10

(52) U.S. Cl. CPC C02F 9/00; B01D 17/0205; B01D 17/0217; B01D 17/047; B01D 19/0036; C02F 1/20; C02F 1/24; C02F 1/385; C02F 1/40; C02F 1/5272; C02F 2101/32; C02F 2103/10; C02F 2201/001; C02F 2301/024; C02F 2303/10

(57) ABSTRACT

The present disclosure provides embodiments that aim at removing oil from produced water resulting from oil extraction through in-line pneumatic flocculation with gas (air) injection into heat exchangers, wherein the heat exchangers are positioned between the hydrocyclone and the floater. In this way, the present disclosure proposes a produced water treatment system including a flash tank (I), a hydrocyclone (II), a flotation unit with reduced or dissolved gas (IV), a heat exchanger (III) arranged between the hydrocyclone (II) and a flotation unit with reduced or dissolved gas (IV), where the pneumatic flocculation occurs.

### FIELD OF THE DISCLOSURE

The present disclosure belongs to the technical field of oil and gas extraction on offshore oil production platforms, more specifically in the treatment of effluents, specially produced water resulting from oil extraction.

### BACKGROUND OF THE DISCLOSURE

Water pollution by oil represents a high percentage of the problems generated by organic contaminants, since fossil fuels, such as oil and its byproducts, are the source of raw material for the generation of energy for most current industrial processes.

The disposal or presence of oil in water impairs the aeration and natural lighting of watercourses, due to the formation of an insoluble film on the surface, producing harmful effects on aquatic fauna and flora.

The current global context prioritizes environmental preservation. Therefore, it is of utmost importance to reduce the quantity and/or improve the quality of effluents discharged into water bodies. This is the challenge that several industrial sectors face in order to achieve adequate development, free from harm to the environment.

The water produced in mature wells resulting from oil extraction is oily water and must be treated because, in addition to being harmful to the environment, it is monitored by the Conselho Nacional do Meio Ambiente (Brazilian Environmental Council) (CONAMA). CONAMA resolution 393/2007 regulates the disposal of water in offshore units. According to this resolution, oil platforms can discharge water produced with an average oil and grease content (OGC) of no more than 29 mg/l, which can reach a maximum daily limit of 42 mg/l. Failure to comply with this resolution may result in notifications of infractions/fines for oil exploration operators in the national territory, which is undesirable.

In order to solve this problem, some technologies in the field of treatment of water produced on oil platforms have been proposed over the years.

Document PI 0502626-1 from 2005 discloses a system for treating liquids (effluents) from the oil industry contaminated by various contaminating agents, such as oils, suspended solids, colloids, fibers, microorganisms, etc. The proposed treatment system allows, for example, the separation of an oil/water emulsion, by means of the flotation technique in a high-capacity centrifugal cell consisting of a mixer-separator set.

Document US 2014/0326677 from 2011 describes a system for treating produced water comprising several steps including microbubble flotation, aeration and ultraviolet ray treatment. This process, however, is complex and has high costs to be implemented.

Document US 2014/054225 from 2012 describes a system and method for treating water produced in oil extraction fields comprising the steps of effluent coagulation and addition of ozone for treatment. This process, however, requires a high investment, in addition to a long time for water treatment.

Document U.S. Pat. No. 8,790,514 from 2013 presents a system with three initial tanks that use the gravitational method to separate the crude oil present in the water, anaerobic treatment and aeration treatment, respectively. After the three tanks, the dissolved gas flotation process occurs. This process, however, requires a large amount of space for the tanks, in addition to restricting the operating time due to the residence time required in each tank.

Document BR 102015002905-5 from 2015 describes a process and a produced water treatment system, based on the coagulation and flocculation process directly in the primary flotation unit, with pH control and adjustment in the secondary unit, with coagulation and flocculation performed in the tertiary unit and filtration in the quaternary unit.

Document U.S. Pat. No. 10,723,643 from 2018 presents a degassing process, followed by chemical treatment and cascade membrane filtration. This process, however, has the disadvantage that the membrane can degrade when subjected to high temperatures, which happens in the case of water produced in oil wells in an offshore environment.

The methods commercially used in the industry to improve the disposal of its effluents can be divided into gravitational separation, hydrocyclone, flotation and filtration. On offshore platforms, the use of hydrocyclones and floaters are the classic methods used to reach the limits defined by environmental standards, due to the high capacity per area and volume, resulting in more compact equipment when compared to other methods.

Document PI 0006390-8 B1 is a now-expired patent relating to equipment and a process for the treatment and recycling of vehicle wash water and similar effluents, such as those containing oils, suspended solids, colloids, fibers or microorganisms, which includes the use of in-line pneumatic flocculation and flotation separation techniques. The process involves adding a flocculant chemical to the liquid to be treated and injecting compressed air. This mixture passes through the pneumatic flocculation device, consisting of two or more chicanes, which jointly promote, through turbulence, the flocculation of the suspended material and the generation of air bubbles. The purified liquid and the flocculated material are then separated in the flotation/sedimentation device. This disclosure allows for a reduction in water consumption, in addition to the equipment being compact, easy to operate and maintain. It offers low investment costs, high treatment capacity and efficiency, and a performance that eliminates up to 90% of turbidity from vehicle wash water and similar effluents.

Although the patent mentions the use of the in-line pneumatic flocculation technique, this process would not be viable for use in the treatment of produced water from offshore oil and gas exploration due to the need to install new equipment in the process, increasing the complexity and costs of the produced water treatment process.

The paper titled “PRODUCED-WATER-TREATMENT SYSTEMS: COMPARISON OF NORTH SEA AND DEEPWATER GULF OF MEXICO”, by J. M. Walsh, published in 2015, addresses to and shows, in general, that water treatment systems can be different depending on the type of seawater. For example, the water treatment systems in the North Sea differ from those in the deep waters of the Gulf of Mexico (GOM). The two main differences are the extensive use of hydrocyclones in the North Sea and the use of large multi-stage horizontal flotation units in the deep waters of the GOM. GOM deepwater platforms also use hydrocyclones, but not to the extent that they are used on typical North Sea platforms. Typically, in the North Sea, if flotation is used, it is a compact, vertical unit. The aim of this paper is to provide an understanding of the reasons for these differences. The study also provides a direct comparison of the performance of North Sea vs. GOM process configurations.

The master thesis “TRATAMENTO COMBINADO DA ÁGUA PRODUZIDA DE PETRÓLEO POR ELETROFLOTAÇÃO E PROCESSO FENTON” (“COMBINED TREATMENT OF OIL PRODUCED WATER BY ELECTROFLOTATION AND FENTON PROCESS”) (2009) has as its main objective to study the treatment of produced water from the oil industry for oil removal by means of the Fenton process, Electroflotation and a combination thereof.

These processes separately present OGC removal values in a limited range. As an alternative, this work combines the Fenton processes and the electroflotation in a reactor design capable of enabling the best OGC removal from the process, given the scarce bibliography on process combinations regarding industrial effluents and, more specifically, the proposed one.

The PhD thesis “TRATAMENTO DE EFLUENTES OLEOSOS POR FLOCULAÇÃO PNEUMÁTICA EM LINHA E SEPARAÇÃO POR FLOTAÇÃO—PROCESSO FF” (“TREATMENT OF OILY EFFLUENTS BY IN-LINE PNEUMATIC FLOCCULATION AND SEPARATION BY FLOTATION—FF PROCESS”) (2009) addresses to the technique of treating oily water (oil removal) based on in-line pneumatic flocculation, followed by flotation. This method, called the FF process, depends on the interaction between the following (main) parameters: pressure drop caused by the air flow rate, bubble generation in flow constrictions, type and concentration of polymeric flocculant, type of flocculator (turbulent) and flotation separation tank.

The flocculation process occurs due to velocity gradients imposed on the flow. These velocity gradients can be obtained by passing the flow through chicanes, by mechanical agitation in flocculation reactors, by passing through granular filters, among others.

A disadvantage of these methods is the long time required for the flocculation process to occur, negatively impacting the maximum possible treatment flow rate. The injection of inert gas into the flocculators increases the level of turbulence in the flow and increases the difference in density between the oil/gas flocs and the water, facilitating the extraction of the former. The efficiency of the flocculators is related to the velocity gradient imposed on the flow and the resulting pressure drop in these equipment.

FIG. 1 presents the results of the study on the efficiency of oil removal in water/oil emulsions as a function of the pressure drop in different flocculators (ME-1, ME-3/4, MS-10, MS-20 and ME-0.5), where in it can be seen that the behavior presented is similar for all flocculators. For all flocculators tested, the removal efficiency improves when the pressure drop values in the flocculator reach 0.5 kgf/cm² (49.03 kPa). For higher pressure drop values, the final oil concentration does not decrease significantly, regardless of the type of flocculator and the oily water flow rate.

However, to be used on offshore oil platforms, the flocculation process must be implemented in-line, so as not to affect the extraction process, and in compact equipment, due to the limited space available.

In practice, the installation of in-line flocculators becomes unfeasible on existing platforms due to the lack of space between and within the equipment and, although possible on new platforms, the installation of additional, large-sized equipment is not desirable.

In order to solve the problem of removing oil from the water produced from oil extraction in a different and more efficient manner than described above, the present disclosure proposes a system and a method of pneumatic flocculation by means of gas (air) injection into heat exchangers, which consists of injecting gas and flocculant into the produced water upstream of these equipment, establishing the dispersed bubble flow pattern, with the heat exchangers positioned between the hydrocyclone and the floater.

The injection of gas (air) and flocculant upstream of the heat exchangers has the benefit of reducing the OGC downstream of this equipment.

Performing oil flocculation prior to flotation increases the average diameter of the gas/oil flocs, facilitating subsequent removal. The injection of the gas bubbles also promotes an increase in the density difference between the gas/oil flocs and the water, improving the efficiency of the flotation and consequently the efficiency of the process.

In this way, the present disclosure uses the heat exchangers, equipment necessary and available on all offshore platforms, to perform the pneumatic flocculation process.

### SUMMARY OF THE DISCLOSURE

The present disclosure aims at removing oil from the water produced and resulting from the extraction of oil through the in-line pneumatic flocculation with gas (air) injection into heat exchangers, wherein the heat exchangers are positioned between the hydrocyclone and the floater.

The main feature consists of improving the efficiency of the process of removing oil from the water produced using the concept of in-line pneumatic flocculation and taking advantage of processes and equipment already present on the platforms, such as inert gas (air) and the heat exchangers. This results in a system that is simple to implement and low cost.

In this way, the present disclosure proposes a produced water treatment system comprising a flash tank (I), a hydrocyclone (II), a flotation unit with reduced or dissolved gas (IV), a heat exchanger (III) arranged between the hydrocyclone (II) and a flotation unit with reduced or dissolved gas (IV), where the pneumatic flocculation occurs. The system further comprises a clean slop tank (V) that collects the streams if they are outside the environmental specification.

The present disclosure also proposes a pneumatic flocculation method by means of the injection of inert gas into heat exchangers, which has the feature of consisting of three steps: i) injection of inert gas upstream of the heat exchanger; ii) pneumatic flocculation in the heat exchanger; and iii) subsequent separation of the oil and gas flocs formed in the hydrocyclones or floaters. This method is briefly illustrated in FIG. 4.

### BRIEF DESCRIPTION OF THE FIGURES

FIG. 1 illustrates the oil removal capacity in floaters with the difference in pressure drop between single-phase and two-phase water/gas flow in the flocculators.

FIG. 2 is a graph illustrating the difference in pressure drop between single-phase and two-phase water/gas flow in a shell-and-tube heat exchanger with inert gas injection.

FIG. 3 is a graph illustrating the difference in pressure drop between single-phase and two-phase water/gas flow in a plate heat exchanger with inert gas injection.

FIG. 4 illustrates the three steps required to treat the produced water using the pneumatic flocculation concept in the heat exchangers.

FIG. 5 is a graph illustrating the flow patterns for two-phase water-gas flow in horizontal tubes.

FIG. 6 is a graph illustrating the flow patterns for two-phase vertical upward water-gas flow between plates.

FIG. 7 illustrates the schematic drawing of the test section.

FIG. 8 is a set of the schematic drawing and the image of the reservoirs used for storage of the test section samples and measurement of the OGC.

FIG. 9 is a graph of the initial results regarding the stability of the emulsion for different experimental conditions.

FIG. 10 is a simplified schematic drawing of the primary processing of the oil, resulting in water produced as a byproduct.

FIG. 11 is a schematic drawing of the proposed produced water treatment with pneumatic flocculation by means of the injection of inert gas into heat exchangers.

### DETAILED DESCRIPTION OF THE DISCLOSURE

The present disclosure discloses a pneumatic flocculation method by means of the injection of inert gas into heat exchangers, which has the feature of consisting of three steps: i) injection of inert gas upstream of the heat exchanger; ii) pneumatic flocculation in the heat exchanger; and iii) subsequent separation of the oil and gas flocs formed in the hydrocyclones or floaters.

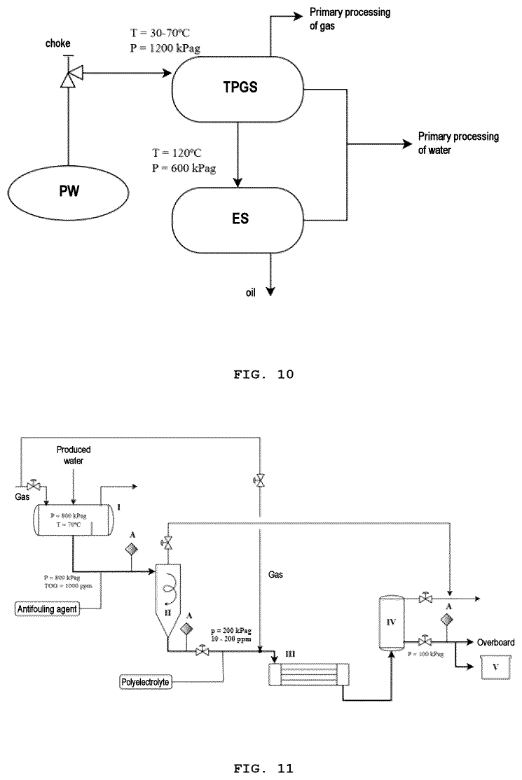

The present disclosure is described by FIGS. 10 and 11 explained below.

FIG. 10 illustrates in a simplified way the equipment used in the primary processing of oil, resulting in the production of water as a byproduct. The multi-phase stream coming from the producing well (PW) can contain the oil, water and gas phases. The water present in oil can be found in free and emulsified forms. Free water consists of large drops (d>1000 μm) and is separated by a three-phase gravity separator (TPGS). Emulsified water is composed of smaller drops (0.1 μm<d<100 μm) and is usually separated in an electrostatic separator(ES). After the separators, the produced water stream contains up to 1000 ppm of OGC (Oil and Grease Content) and is directed to the Produced Water Treatment System, which is the focus of this disclosure. The temperature and pressure at each step of the process depend on the features of the producing well and FIG. 10 illustrates some typical values.

FIG. 11 presents the schematic of the produced water treatment system, which aims at recovering part of the oil present in the water in the form of an emulsion and prepare the same for disposal at sea. The system includes batteries of hydrocyclones (II) and induced or dissolved gas flotation units (IV). Among these sets of equipment is a heat exchanger (III), where the pneumatic flocculation occurs.

The produced water, separated in the gravitational separator (TPGS) and in the electrostatic separator(ES) (FIG. 10), is collected by the flash tank (I), where the gas is separated from the liquid before the produced water is sent to the battery of hydrocyclones (II). This equipment is responsible for removing oily residues from the water. There is a sampling point (A) in the hydrocyclone inlet line for sample collection. At this point, a maximum OGC of 1000 ppm is expected. The flow of oily waste from the hydrocyclone is controlled by means of pressure control valves in the oily waste outlet line and in the water outlet line. Another sampling point (A) is located at the hydrocyclone outlet line, where a maximum OGC of 200 ppm is expected. The water outlet flow rate from the hydrocyclones is controlled to maintain a constant liquid level in the Flash Tank (I).

After passing through the hydrocyclones, the water still contains oily drops, especially those with a smaller diameter, which are more difficult to separate. For this reason, it is important to carry out the pneumatic flocculation process between the hydrocyclones and the floater. At this step, the emulsion is destabilized and oily flocs are formed, with a size greater than 50 μm but less than 1000 μm.

To carry out the pneumatic flocculation, the polyelectrolyte and the gas are injected before the heat exchanger (III). The polyelectrolyte consists of polymeric molecules and can be used as a flocculant in a system previously destabilized by a coagulant, or as the agent responsible for the flocculation and coagulation processes. Its operating principle depends on the charge (cationic, anionic, neutral), hydrophobicity, molecular weight and structure. The most common flocculation mechanism consists of particle aggregation by polymeric bridges, when the polyelectrolytes adsorb at the interface of the oil drops and form flocs larger than 50 μm. When cationic polymeric molecules are used, the positive charges associate with the negative charges of the oil drops emulsified in the water, facilitating the adsorption process. The injection of the polyelectrolyte should preferably be performed before the injection of gas (air) into the flow. The experiments were performed with the dithiocarbamate flocculant, which is an anionic polymer used as a water clarifier. However, other flocculants can also be used, such as cationic, anionic or neutral polyacrylamides. The ideal flocculant depends on the characteristics of the water produced and requires laboratory testing for verification.

Gas injection promotes the rapid mixing of the flocculant throughout the cross-section of the tube, which is an important step for the efficiency of the pneumatic flocculation process.

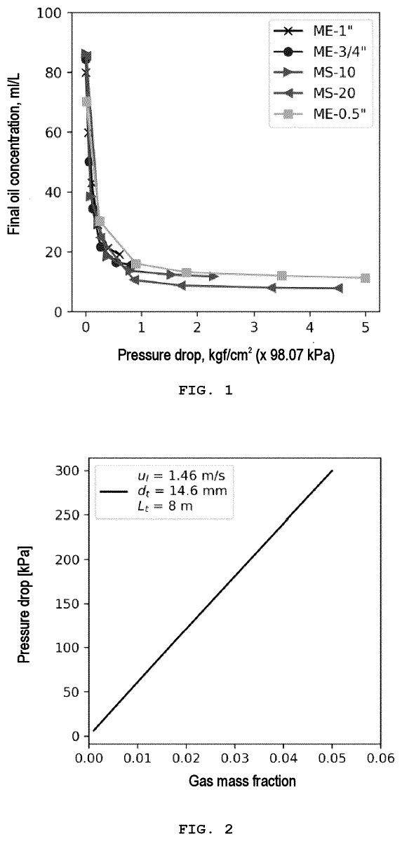

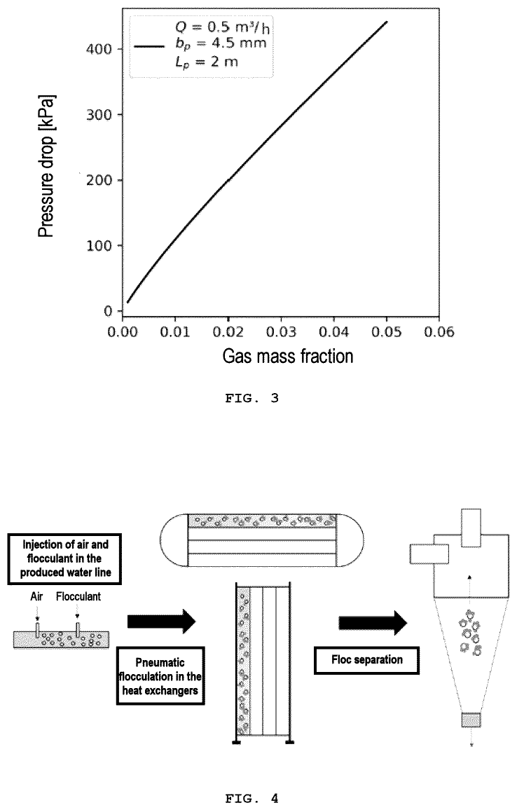

The heat exchanger (III) provides the necessary turbulence in the flow for the process to occur, as demonstrated by the pressure drop indicated in FIG. 1 and simulated by FIGS. 2 and 3. The increase in drop size, promoted by the pneumatic flocculation, reduces the residence time required in the floater, improving the efficiency and capacity of the system. The residence time adopted in the initial experiments was 10 min, but new tests are underway to evaluate the effect of residence time on the pneumatic flocculation. For the residence time of 10 min, a reduction of approximately 50% was obtained with the injection of air in the pilot prototype (FIG. 9).

After the pneumatic flocculation process, the produced water is directed to the floaters (IV), where the smaller fractions of oily residues are removed through flotation. The outlet flow rate of the floaters is controlled to maintain a constant liquid level in the unit. At the outlet of the floaters (IV), there is a sampling point (A) where the oil content is checked by the analyzer, which will direct the stream within the environmental requirements (≤29 ppm of oil) for disposal overboard. If the effluent stream from the floaters is outside the environmental requirements (>29 ppm of oil), the stream will be sent to the clean slop tank (V).

The system is designed to work with different operational variables. The process was tested at temperatures from 30 to 90 degrees Celsius and pressures from 1 to 12 bar (0.1 to 1.2 MPa), preferably 1 to 6 bar (100 to 600 kPa). An important process variable is the Reynolds number of the flow, with tests performed at values from 10,000 to 55,000 (turbulent regime). This means that the maximum capacity of the system can be increased as required, respecting the optimum Reynolds number range for the process, which can be controlled by the relation between flow rate and diameter of the exchanger tubes.

Existing produced water treatment systems rely on a large drop size distribution (d>1000 μm) to operate efficiently. However, this distribution is not guaranteed in specific oil processing systems. Smaller droplets may be present if there are sources of shear in the system, upstream of the produced water treatment unit, such as choke valves at the wellhead or pipeline connections. Oil drops have a negative electrostatic charge due to the adsorption of hydroxyl ions (OH⁻) at the oil/water interface. This charge makes it difficult for the droplets to coalesce, resulting in a stable drop distribution when the charge is sufficiently high. Waters with higher salinity reduce the electrostatic charge on the droplets, allowing for greater coalescence. Therefore, condensed waters in condensate gas fields, which generally have low salinity, contain droplets with greater repulsion. To neutralize the effect of repulsion on charged droplets, it is necessary to neutralize the electrostatic charge. This is accomplished by injecting cationic salts into the produced water treatment system. These salts must be oleophilic to be active in the oily phase and must have one or more alkyl hydrocarbon groups. The positive charge of the cation must be sufficient to neutralize or reduce the negative electrostatic charge of the droplets, but must not overcompensate, resulting in a net positive charge on the droplets.

The chemicals that perform this function are known as polyelectrolytes or flocculants. The rate of this chemical dosage can vary from 10 to 200 ppm, depending on the specific compound, with 10 to 100 ppm being most common. The experiments were performed with the dithiocarbamate flocculant, which is an anionic polymer used as a water clarifier. However, other flocculants can also be used, such as cationic, anionic or neutral polyacrylamides. For the chemical compound to act efficiently, adequate turbulent mixing is required. In addition, the chemical must be injected as close as possible to the inlet of the produced water treatment system. The gas injection downstream of the polyelectrolyte injection point is justified because the polyelectrolyte mixture is more efficient due to the greater turbulence of the flow after the gas injection.

These last two characteristics are the main challenges of current produced water treatment systems on offshore platforms. Before the hydrocyclones, there is still a high concentration of oil (1000 ppm), including both free oil and emulsified oil with a larger average drop diameter (d>1000 μm), which allows separation in the hydrocyclones. Therefore, the injection of the chemical product must be done after the hydrocyclones, when the emulsified oil with a smaller average diameter between 10 and 50 μm and a OGC of 50 to 200 ppm remains. However, the efficiency of the process is limited, since the chemical compound is injected immediately before the floaters and there is no process to increase the turbulence of the flow. Thus, the present disclosure combines the concept of pneumatic flocculation with existing produced water treatment systems. The injection of air (gas) immediately after the injection of the polyelectrolyte promotes the rapid mixing of the chemical, which is an important step for the efficiency of the compound. Next, the floc formation process occurs in the heat exchanger, increasing the average diameter of the oil drops dispersed in the water (oil-in-water emulsion (O/W)) to the range between 10 and 50 μm and facilitating the final removal of the oil within the parameters permitted by CONAMA 393/2007.

FIGS. 2 and 3 represent the resulting pressure drop in the shell-and-tube and plate heat exchangers, respectively, with the injection of gas for a flow condition observed on the offshore platforms. The injection of gas in this equipment promotes the pressure drop suggested in FIG. 1 and consequently the decrease in the oil concentration. The air flow rate affects the increase in the pressure drop (FIGS. 2 and 3). The higher the gas mass fraction (related to the flow rate), the higher the pressure drop. The gas mass fraction range shown is 0.01 to 0.05 (dimensionless). The mass fraction consists of the ratio between the gas mass flow rate and the total mass flow rate. Thus, the gas flow rate range depends on the liquid flow rate range.

In FIG. 2, a shell-and-tube heat exchanger with 1300 316 stainless steel horizontal tubes with an internal diameter of 14.6 mm (external diameter ¾″ (1.905 cm) and thickness 14 BWG (2.108 mm)) and a total length of 8 m was considered, with a total liquid mass flow rate of 287880 kg/h, resulting in an internal liquid velocity (vt) in each tube of 1.46 m/s.

In FIG. 3, a plate heat exchanger with a corrugation (bp) of 4.5 mm, plate length (Lp) of 2 m and volumetric flow rate of liquid per plate (Q) of 0.5 m³/h was considered. The gas mass fraction consists of the mass flow rate of the gas over the total mass flow rate of the flow. Thus, by simulating the pressure drop in the equipment with the gas injection, it is possible to estimate the gas flow rate to be injected into the equipment for the pneumatic flocculation to occur.

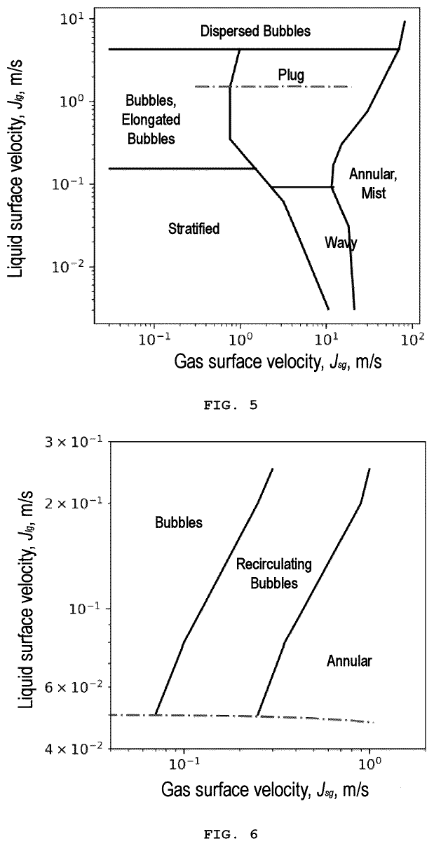

In addition to the pressure drop in the equipment, the flow pattern in the heat exchangers must be considered for better method efficiency. The flow patterns predicted for different experimental conditions are simulated in FIGS. 5 and 6, for the shell-and-tube and plate heat exchangers, respectively. The conditions simulated in FIGS. 2 and 3 are also identified by the red dashed line in FIGS. 5 and 6.

FIGS. 2 and 3 indicate that the higher the gas injection fraction, the higher the pressure drop. This increase in pressure drop can be explained by the increase in flow velocity as the gas injection fraction increases (increase in frictional pressure drop). In addition, the gas-liquid flow (two-phase flow) assumes specific configurations called flow patterns (FIGS. 5 and 6), which are determined from the superficial velocity of liquid (Jl) and gas (Jg) in the flow. FIGS. 5 and 6 are flow pattern maps for a gas-liquid (two-phase) horizontal flow, which show that the flow patterns (e.g., bubble pattern, elongated bubble pattern, and plug pattern (see FIG. 5)) observed in a horizontal gas-liquid flow are functions of the liquid superficial velocity (Jl, which is associated with the liquid flow rate) and the gas superficial velocity (Jg, which is associated with the gas flow rate). In addition, the pressure drop observed in two-phase (gas-liquid) flow is affected by the flow pattern, as well as other parameters such as pipeline diameter, pipeline roughness, temperature, phase properties (density, dynamic viscosity, etc.). Therefore, FIGS. 2 and 3 are related to FIGS. 5 and 6, because as the gas fraction increases in FIGS. 2 and 3, there is an increase in the pressure drop due to the increase in velocity and the transition of the flow pattern, such as the transition from the bubble flow pattern to the plug flow pattern (see FIG. 5). Regarding the pneumatic flocculation process, in addition to the optimum pressure drop illustrated in FIGS. 1, 2 and 3, considering the main function of the heat exchanger, it is suggested to maintain the bubble and plug flow pattern, avoiding a degradation of its main function. Therefore, the aforementioned graphs should be analyzed together.

In FIG. 5, the gas is expected to flow in the characteristic envelope of the “Dispersed Bubbles” or “Elongated Bubbles” flow pattern, improving the turbulence promoted in the flow and avoiding a possible drop in the heat transfer rate due to the formation of gas pockets (plug). In FIG. 6, experimental conditions are expected within the envelope of the “Bubbles/Recirculating Bubbles” patterns. The surface velocities are calculated from the volumetric flow rates of the liquid phases and the cross-sectional area of the tube/plate.

In this way, the experimental matrix consists of liquid phase velocities ranging from 0.1 to 3.5 m/s, gas phase velocities from 0.1 to 10 m/s and initial oil-in-water concentrations of 100 mg/L.

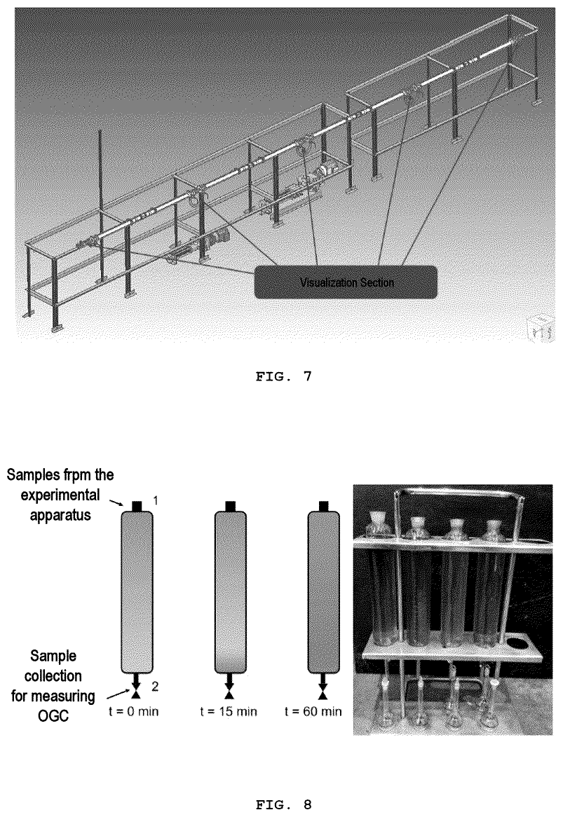

FIG. 7 presents the schematic drawing of the test section. The section consists of a 316 stainless steel horizontal tube with an internal diameter of 14.8 mm (external diameter ¾″ (1.905 cm) and thickness 14 BWG (2.108 mm)) and a total length of 9 meters. The annular region of the test section was designed to conduct single-phase water flow in order to reproduce the heat exchange observed in heat exchangers. In addition, 5 visualization sections were installed for the internal tube in order to evaluate the flow development with the injection of air along the heat exchanger. The visualization sections consist of borosilicate tubes with an internal diameter of 14.8 mm, installed every 2 meters. The pneumatic flocculation concept is evaluated according to the stability of the emulsion along the test section. This evaluation consists of measuring the oil and grease content (OGC) of three emulsion samples (O/W), which are extracted from each experimental condition.

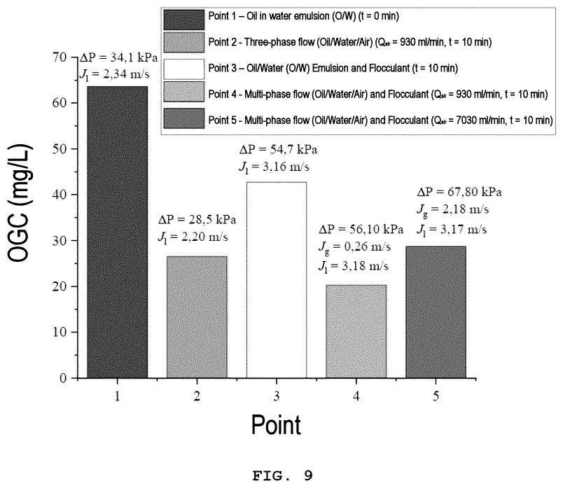

The emulsion samples are extracted from the collectors along the test section and stored in ascending reservoirs with a volumetric capacity of 1.0 L, as shown in FIG. 8. The OGC measurement is performed in three periods (t): i) 0 min, (ii) 15 min, (iii) 60 min. After the sedimentation time (t) of each sample, a fraction of the emulsion (around 50 ml) is collected in the lower position of the reservoir (FIG. 8) and stored in a 100 ml volumetric flask. After collecting all three samples, the OGC measurement is performed.

The molecular absorption spectrophotometry technique was used to measure the OGC, which consists of the concentration, in mg/L, of substances present in a water sample, soluble in n-hexane, quantified by the molecular absorption spectrophotometry method, at a wavelength of 400 nm. Approximately 500 ml of sample are extracted at least twice with n-hexane in a separatory funnel. The extract is dried with sodium sulfate, made up to 100 ml in a volumetric flask and the absorbance is read at 400 nm in a molecular absorption spectrophotometer. The procedure was followed in accordance with API RP 45 standard.

FIG. 9 illustrates the initial results obtained. A reduction in the OGC value can be observed with the injection of air (Point 2), when compared to the injection of flocculant alone (Point 3). The joint injection of air and flocculant (Point 4) showed a higher potential than the other conditions.

### Analysis and Results Obtained From the Disclosure

Experiments using a shell-and-tube heat exchanger were carried out in three operating conditions through: i) injection of gas (air) at the inlet of the pilot unit; ii) injection of flocculant (dithiocarbamate); and iii) combined injection of gas (air) and flocculant (dithiocarbamate).

The injection of gas (air) promoted a reduction in OGC by 58% in relation to the flow of an oil-in-water (O/W) emulsion, characterized by a OGC of 63.6 mg/l (reference experiment-point 1), that is, the OGC value obtained was 26.71 mg/l (point 2).

The injection of flocculant reduced the OGC to 42.7 mg/l (point 3), which represents a reduction of 33% in comparison with the reference experiment (emulsion (O/W), OGC=63.6 mg/l).

The combined injection of gas (air) and flocculant (dithiocarbamate) favored a 68% reduction in OGC compared to the reference experiment (emulsion (O/W), OGC=63.6 mg/l), that is, the OGC value obtained was 20.35 mg/l (point 4).

Additional experiments are underway with the aim of mapping the optimal conditions for gas (air) and flocculant injection. Furthermore, the preliminary results indicate that the combined injection of gas (air) and flocculant upstream of heat exchangers has the potential to reduce the OGC downstream of this equipment, which favors the unitary flotation operation, usually applied in the treatment of effluents (oily water) in an offshore environment.

This combination also ensures that the water produced has a OGC within the standards permitted by the CONAMA resolution, that is, a maximum of 29 mg/l. Therefore, the use of the pneumatic flocculation with gas injection into heat exchangers becomes viable in this field, since in an offshore environment, natural gas (CH₄) is abundant.

Furthermore, the injection of gas into the heat exchanger promotes the intensification of the heat transfer, in addition to favoring the reduction of fouling in the equipment.

1. A system for treating produced water resulting from oil extraction, the system comprising a flash tank, a hydrocyclone, a flotation unit with reduced or dissolved gas, and a heat exchanger arranged between the hydrocyclone and the flotation unit with reduced or dissolved gas, and wherein pneumatic flocculation occurs.

2. The system according to claim 1, further a clean slop tank that collects streams if the streams are outside environmental specification.

3. The system according to claim 1, further comprising a sampling point in an inlet line of the hydrocyclone for sample collection.

4. The system according to claim 1, further comprising a sampling point located in an outlet line of the hydrocyclone.

5. The system according to claim 1, further comprising a sampling point located in an outlet line of the floater where oil content is checked by an analyzer.

6. The system according to claim 1, wherein operation occurs at temperatures of 30° C. to 90° C.

7. The system according to claim 1, wherein operation occurs at pressures of 1 to 12 bar (0.1 to 1.2 MPa).

8. The system according to claim 1, wherein operation occurs with the flow at a Reynolds number of 10,000 to 55,000, that is, in a turbulent regime.

9. The system according to claim 1, wherein the heat exchanger comprises a shell-and-tube or a plate type.

10. A pneumatic flocculation method by injection of inert gas into heat exchangers, the method comprising:
i) injection of inert gas upstream of the heat exchanger (III);
ii) pneumatic flocculation in the heat exchanger; and
iii) subsequent separation of oil and gas flocs formed in one or more hydrocyclones or one or more floaters.

11. The method according to claim 10, wherein the pneumatic flocculation is carried out between the one or more hydrocyclones and the one or more floaters.

12. The method according to claim 10, wherein the injection of polyelectrolyte occurs prior to the heat exchanger.

13. The method according to claim 12, wherein the polyelectrolyte comprises a flocculant composed of polymeric molecules.

14. Method according to claim 12, wherein the polyelectrolyte comprises dithiocarbamate.

15. The method according to claim 12, wherein the flocculant dosage rate comprises 10 to 100 ppm.

16. The method according to claim 12, wherein the flocculant is injected as close as possible to the inlet of the produced water treatment system.

17. The method according to claim 10, wherein the air (gas) injection is made immediately after the injection of the polyelectrolyte to promote the rapid mixing of the chemical product.

18. The method according to claim 10, wherein the heat exchangers comprises a shell-and-tube or a plate type.
